(19) United States
(12) Patent Application Publication
(10) Pub. No.: US 2016/0174574 A1
(43) Pub. Date: Jun. 23, 2016

(54) FORCED MOISTURE EVACUATION FOR RAPID BAKING OR COOKING

(71) Applicant: Middleby Marshall Holdings LLC d/b/a NUVU Food Service Systems, Menominee, MI (US)

(72) Inventors: Matthew E. Deming, Peshtigo, WI (US); Mark E. Halpin, Plattsburgh, NY (US); Sarah J. Tresser, Williston, VT (US); Jonathan D. Ewing, Colchester, VT (US); Sean M. Preavy, Essex Junction, VT (US); Daniel J. Swayze, Colchester, VT (US)

(73) Assignee: Middleby Marshall Holdings LLC d/b/a NUVU Food Service Systems, Menominee, MI (US)

(21) Appl. No.: 14/966,961

(22) Filed: Dec. 11, 2015

Related U.S. Application Data
(60) Provisional application No. 62/095,924, filed on Dec. 23, 2014.

(51) Int. Cl. A21B 3/04; F24C 15/32

(52) U.S. Cl. CPC A21B 3/04; F24C 15/322; F24C 15/327

(57) ABSTRACT

A baking device is provided. The baking device includes a housing enclosing a baking compartment, the baking compartment enclosed by top and bottom walls, right and left walls, and a door that is pivotably mounted to the housing, the housing further comprising a vent that fluidly connects the baking compartment to the atmosphere and is arranged to allow fluid communication of air within the baking compartment to exit the housing. A blower arranged in fluid communication with the housing, and configured to, when operating, urge air into the baking compartment from the ambient, wherein operation of the blower forces air from within the baking compartment to flow out of the housing to an environment outside of the housing through the vent.

### CROSS-REFERENCE TO RELATED APPLICATIONS

This application claims priority from U.S. Provisional Application No. 62/095,924, filed on Dec. 23, 2014, the entirety of which is hereby incorporated by reference herein.

### TECHNICAL FIELD

The technical field of the disclosure is related to baking or cooking ovens.

### BRIEF SUMMARY

A first representative embodiment of the disclosure is provided. The embodiment includes a baking device. The baking device includes a housing enclosing a baking compartment and an air handling compartment, the air handling compartment and the baking compartment being separated by a pressure panel that defines a rear wall of the baking compartment, the pressure panel including an aperture allowing fluid communication between the baking and air handling compartments. A blower wheel is mounted in conjunction with the aperture, such that rotation of the blower wheel urges air movement from the baking compartment and into the air handling compartment. A secondary blower is arranged in fluid communication with the air handling compartment, wherein operation of the secondary blower urges ambient air into the air handling compartment or the baking compartment.

Another representative embodiment of the disclosure is provided. The embodiment includes a method of baking a food product. The method includes the steps of receiving a food product within a baking compartment of a baking device. The method further includes the steps of operating a secondary blower to inject ambient air into the baking compartment before or during the baking process of the food product.

Yet another representative embodiment of the disclosure is provided. The embodiment includes a baking device. The baking device includes a housing enclosing a baking compartment, the baking compartment enclosed by top and bottom walls, right and left walls, and a door that is pivotably mounted to the housing, the housing further comprising a vent that fluidly connects the baking compartment to the atmosphere and is arranged to allow fluid communication of air within the baking compartment to exit the housing. A blower arranged in fluid communication with the housing, and configured to, when operating, urge air into the baking compartment from the ambient, wherein operation of the blower forces air from within the baking compartment to flow out of the housing to an environment outside of the housing through the vent.

Yet still another representative embodiment of the disclosure is provided. The embodiment includes a method of baking a food product. The method includes the steps of receiving a food product within a baking compartment of a baking device and operating a heater to increase or maintain the temperature within the baking compartment. The method further comprises the steps of providing a blower arranged in fluid communication with the baking compartment, the blower configured to, when operating, urge air into the baking compartment from the ambient to, wherein operation of the blower forces air from within the baking compartment to flow out of the housing to an environment outside of the housing through the vent.

Yet still another embodiment of the disclosure is provided. The embodiment includes a baking device. The baking device includes a housing enclosing a baking compartment, the baking compartment enclosed by top and bottom walls, right and left walls, and a door that is pivotably mounted to the housing, the housing further comprising a vent that fluidly connects the baking compartment to the atmosphere and is arranged to allow fluid communication of air within the baking compartment to exit the housing. A blower is arranged in fluid communication with the housing, and configured to, when operating, urge air from the baking compartment into the vent. A discharge of the blower is gaseously connected to an environment outside of the housing with a first flow path, and the vent merges with the first flow path, such that flow of air from the blower through the first flow path urges air to flow through the vent from the baking compartment and to the first flow path. The blower is operatively connected with a controller, such that the blower operates in response to a signal from the controller.

Yet another embodiment of the disclosure is provided. The embodiment includes a baking device. The baking device includes a housing enclosing a baking compartment, the baking compartment enclosed by top and bottom walls, right and left walls, and a door that is pivotably mounted to the housing, the housing further comprising a vent that gaseously connects the baking compartment to the atmosphere and is arranged to allow gaseous communication of air within the baking compartment to exit the housing. A blower is arranged in gaseous communication with the housing, and configured to, when operating, urge air from the baking compartment into the vent.

Yet another embodiment of the disclosure is provided. The embodiment includes a method of baking a food product. The method includes the steps of receiving a food product within a baking compartment of a baking device and operating a heater to increase or maintain the temperature within the baking compartment. The method additionally includes the step of providing a blower arranged in gaseous communication with the baking compartment, the blower configured to, when operating, urge air within the baking compartment to flow to the environment through a vent provided in gaseous communication with the baking compartment.

Advantages of the disclosed apparatus and method will become more apparent to those skilled in the art from the following description of embodiments that have been shown and described by way of illustration. As will be realized, other and different embodiments are contemplated, and the disclosed details are capable of modification in various respects. Accordingly, the drawings and description are to be regarded as illustrative in nature and not as restrictive.

### BRIEF DESCRIPTION OF THE DRAWINGS

FIG. 1 is a perspective view of a portion of a baking compartment and an air handling compartment of a baking device.

FIG. 2 is a right side view of the view of FIG. 1.

FIG. 3 is a view of detail A of FIG. 1.

FIG. 4 is a view of a portion of the air handling compartment of FIG. 1 from the rear of the baking device.

FIG. 5 is a flow-chart of the steps used by the device of FIG. 1 in performing a proofing and baking cycle.

FIG. 6 is a schematic right side sectional view of a portion of another baking device.

FIG. 7 is a schematic right side sectional view of another baking device.

FIG. 8 is a schematic right side sectional view of another baking device.

### DETAILED DESCRIPTION OF THE DRAWINGS AND THE PRESENTLY PREFERRED EMBODIMENTS

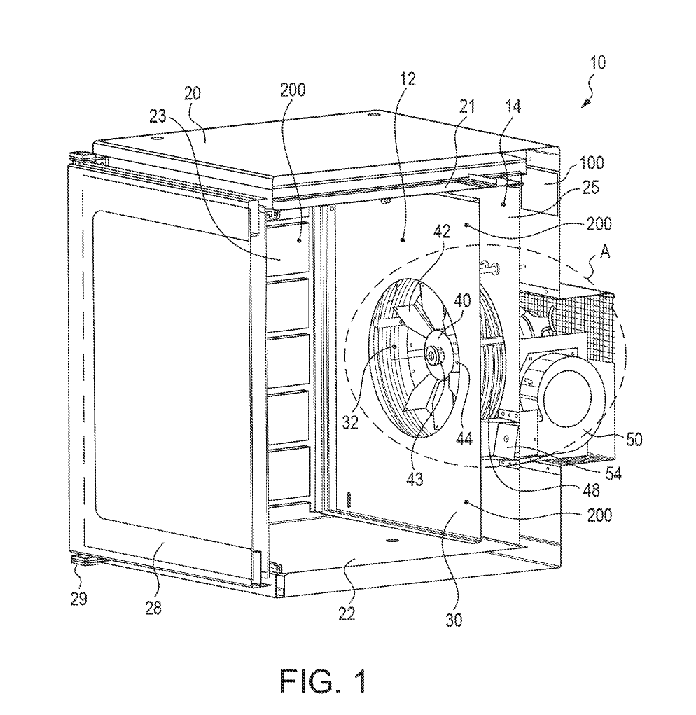

Turning now to FIGS. 1-4, a baking device 10 is provided. The baking device 10 may be configured to cook or bake a food product within the baking device. The term “baking” is used to refer to both the process of baking or cooking or other processes within a conventional enclosed oven in the restaurant industry or the food processing industry (or for residential use) unless specifically noted herein. In other embodiments, the baking device may be configured to “proof” an unrisen food product (such as dough, or combinations of dough and other foods, or other types of food products that might be known in the art to require, or benefit from, a proofing operation and a baking operation, in series) provided within a baking volume 12 of the device as well as bake the food product disposed therein. As is well known in the art, “proofing” a food product is known as allowing time for the food product (such as un-risen dough) to rise prior to cooking, which may expeditiously occur in an environment with a relative high humidity, and with a temperature over normal ambient temperature, such as about 105 degrees Fahrenheit. In some embodiments, the baking device 10 may be configured to both perform the proofing and baking steps and to automatically align itself for proofing as well as for baking, such that both operations can occur within the baking device 10 without any operator action.

The baking device 10 includes a housing 20 that encloses a baking volume 12 and an air handling compartment 14. The baking compartment 12 is defined by an upper wall 21, a right wall 23, a left wall (not shown, but similar to the right wall), a lower wall 22, and a pressure panel 30 that forms the rear wall of the baking compartment 12. The walls that form the baking compartment 12 are each rigidly mounted to the housing 20 of the baking device 10 with suitable support and fastening structures as known in the art. The baking compartment 12 is normally enclosed by one or two doors 28 that are pivotably mounted to the housing 20 and can be selectively opened and closed to selectively enclose the baking compartment 12 and allow access therein.

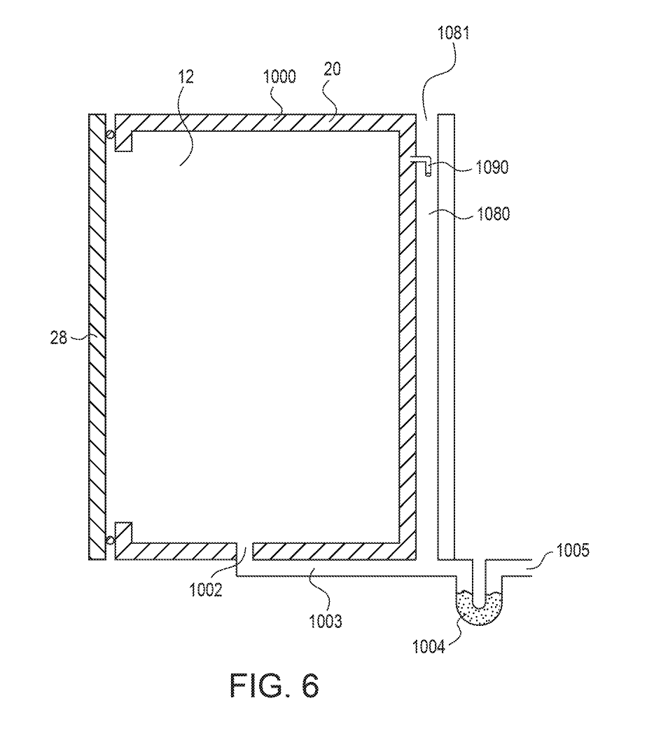

In some embodiments, the baking compartment 12 is vented to the atmosphere through a vent 80, which communicates with the baking compartment 12 through a vent opening 82 As discussed below and depicted in FIG. 6, the baking compartment 12 may alternatively be vented through a drain 1002. The vent 80 may be open to the atmosphere, or in some embodiments may be controlled by a door, which is operatively controlled to expose or conceal the vent by the controller 100 (shown schematically in FIG. 1).

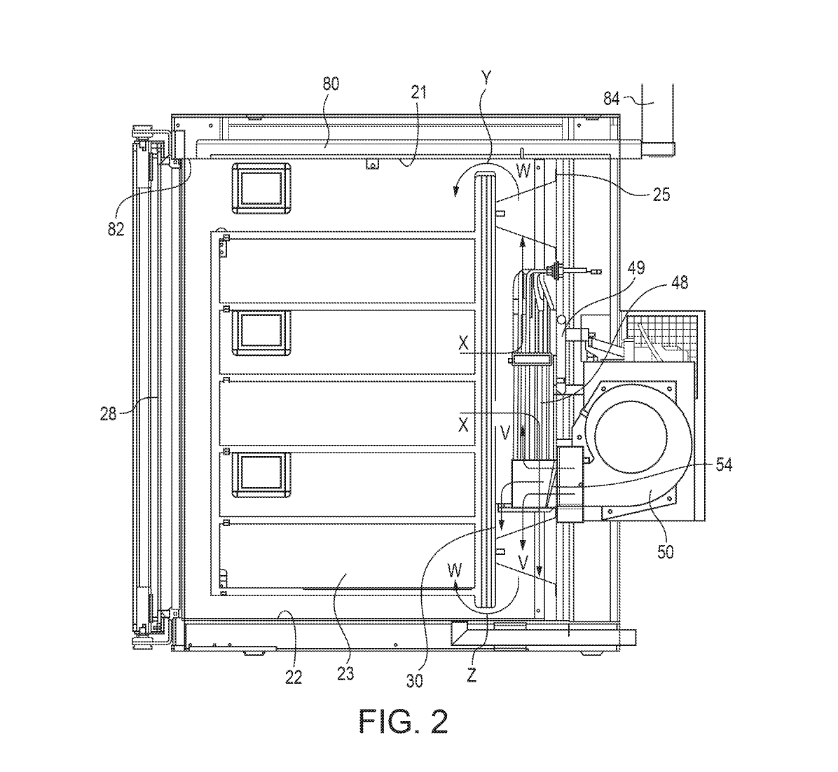

The housing 20 further encloses an air handling compartment 14, which is partially enclosed by the pressure panel 30, as well as portions of the housing 20 that enclose the upper, lower, rear and side walls of the air handling compartment 14. The air handling compartment 14 includes a blower wheel 40 that is rotatably connected to a motor. The blower wheel 40 includes a plurality of fins 42 that extend from a rotor 43 of the blower wheel 40. The blower wheel 40 may be mounted in conjunction with an aperture 32 in the pressure panel 30 that allows for air to flow from the baking compartment 12 and into the blower wheel 40 when the blower wheel 40 is rotating. As shown schematically in FIG. 2, rotation of the blower wheel 40 urges air to flow along the flow-path X, i.e. from the baking compartment 12, through the aperture 32, into the blower wheel 40 and then radially outward from the blower wheel 40.

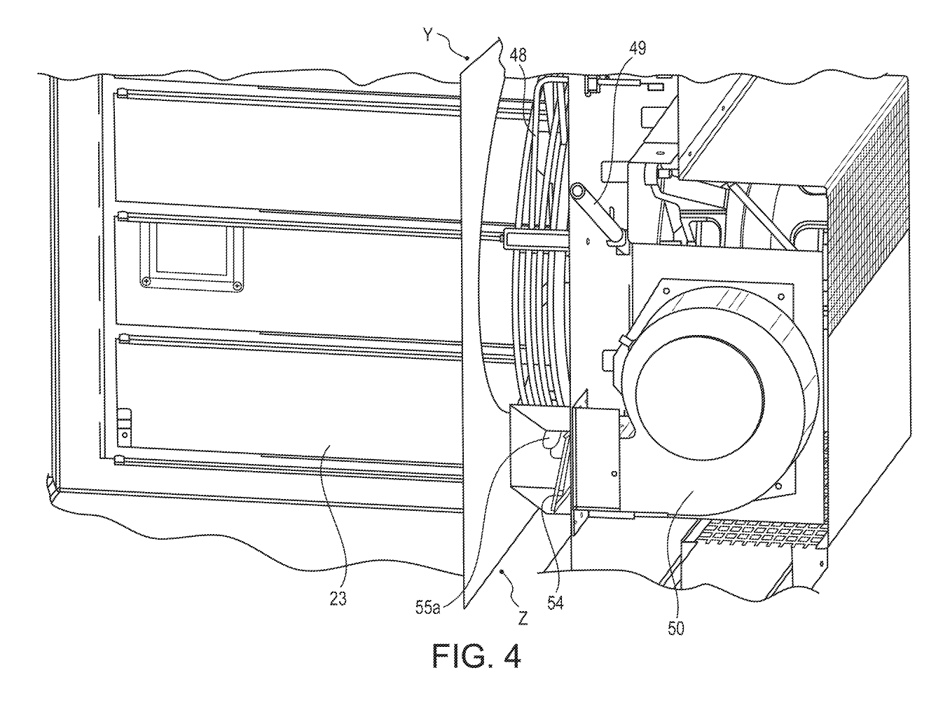

The blower wheel 40 may further include one or more spouts 44 that are disposed upon the rotor 43 of the blower wheel (or another suitable location upon or with respect to the blower wheel 40). The spouts 44 are configured to spray water onto the fins 42 (or another portion) of the blower wheel 40 as it is rotating. The water spray is “cut” by the fast moving blower wheel, which atomizes the water and increases the humidity within the air handling compartment 14 and the baking compartment 12 (due to the air flow pattern discussed below). The controller (shown schematically as 100) is operationally connected to the blower wheel 40 (as well as other portions of the baking device 10, such as the heaters 48) to selectively operate the blower wheel 40 and the injection of water through the spouts 44, based upon the operation of a water system 49 (FIGS. 2 and 4), or in other embodiments allow steam to enter into the baking compartment 12 from an external steam generator. For the sake of brevity, this specification specifically depicts electric heaters 48, but one of ordinary skill in the art would appreciate that the device could additionally or alternatively use gas burners to provide heat when gas service is available and desired, and the use of “heaters” herein should be understood to describe both electric heaters 48 as well as gas burners unless specifically described in a more limiting fashion herein.

As mentioned above, the air handling compartment 14 is separated from the baking compartment 12 by the pressure panel 30. The pressure panel 30 may be mounted to a plurality (such as four) standoffs (not shown) that are fixed to the back panel 25. In other embodiments, the pressure panel 30 may be mounted to one or both of the right side wall 23 and the left side wall, such that an edge of the pressure panel 30 rests snuggly upon the right side wall 23 and the left side wall, or with a mounting structure therebetween. In some embodiments, the pressure panel 30 and one or both of the upper and lower walls 21, 22 define an upper space Y and a lower space Z, respectively, therebetween that allows for fluid communication from the air handling compartment 14 to the baking compartment 12.

In some embodiments, the upper space Y and/or the lower space Z may extend along the entire width of the baking compartment 12, while in other embodiments, the upper space Y and/or the lower space Z may extend along only a portion of the width of the baking compartment 12, and may be centered within the baking compartment 12 or offset within the baking compartment 12. As best appreciated by FIG. 2 (and discussed further below), the upper space Y and lower space Z each provide a space for air flow from the air handling compartment 14 to return to the baking compartment 12 (shown schematically as W), which is urged due to forced flow when the blower wheel 40 is rotating, as well as when the secondary blower 50 (discussed below) is operating.

In other embodiments, the pressure panel 30 may be mounted to one or both of the upper and lower panels 21, 22 with gaps formed between the side edges of the pressure panel 30 and respective right panel 23 and/or left panel (left panel not shown but similar to the right panel 23). The air flow from the air handling compartment 14 to the baking compartment 12 in this embodiment would be similar to the air flow path W depicted in FIG. 2 although one of ordinary skill would easily understand that the flow path would be between the side gaps between the pressure panel 30 and the side walls.

The air handling compartment 14 further includes a secondary blower 50 that is mounted to inject air (which may be drawn from the ambient or from another source) into the air handling compartment 14 (or in other embodiments the secondary blower 50 may inject air directly into the baking compartment 12). The secondary blower 50 is configured to operate to inject air into the baking device 10 to increase the pressure within the housing 20, and specifically the baking compartment 12, to urge the air to exit the baking compartment 12 through the vent 80 (discussed above) (or drain 1002 as discussed below). While, for the sake of brevity, the term “air” is used to describe the gaseous flow into and exiting the housing, and specifically the baking compartment 12 or the air handling compartment 14 through the vent 80, one of ordinary skill in the art will understand that this will include air, other gasses that may be entrained within the air, and any moisture that may be entrained within the air depending upon the humidity level within the housing 20, and the term “air” should be understood to refer to each of these as appropriate unless specifically referred to in a more limiting fashion herein.

As shown schematically in FIG. 2, during operation of the secondary blower 50, air enters into the air handling compartment 14 (or directly into the baking compartment 12) from the discharge of the secondary blower 50 as shown as path V, and upon interaction with the rear surface of the pressure panel 30, either flows upward (past the blower wheel 40) and into the baking compartment 12 through the upper space Y, or downward and into the baking compartment through lower space Z. The secondary blower 50 normally operates when the one or more doors 28 are closed to allow the environment within the baking compartment 12 to be changed out (i.e. the relatively hot air and or the relatively humid air) rapidly due to the pressure increase within the baking compartment 12, which urges air within the cooking compartment 12 to exit through the vent 80. In some embodiments, the secondary blower 50 (operating in conjunction with the other features of the baking device 10) allows for the device 10 to change between “proofing” and baking configurations in a relatively rapid manner and without any operator action or manual reconfiguration of the device.

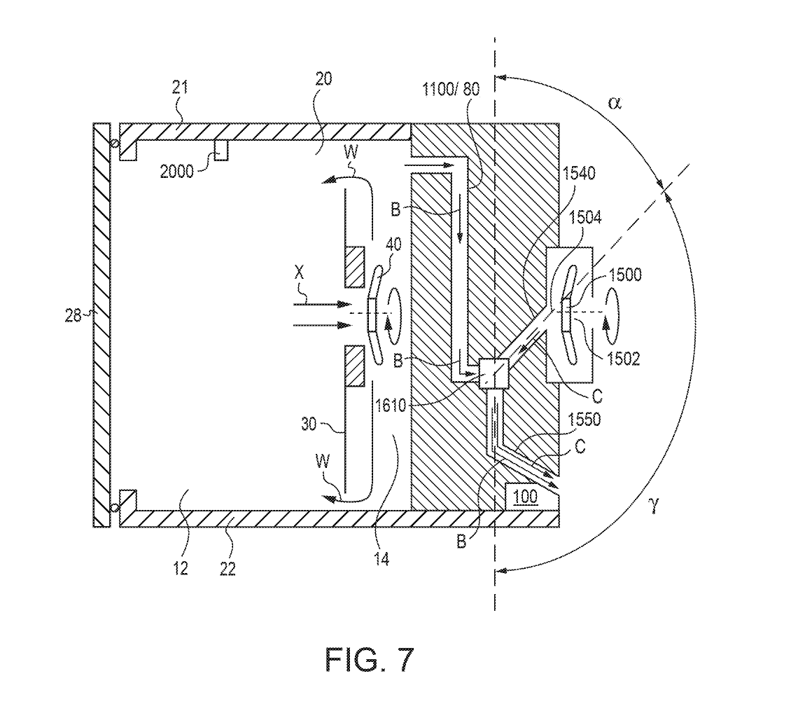

Alternatively, or additionally, the secondary blower 50 may be operated periodically before or during a baking process to evacuate air with a relatively high moisture content and replace that evacuated air with dryer ambient air from the secondary blower 50 (i.e. in addition to the operation of the secondary blower 50 after a process, or for oven operation when not associated with a proofing step). The operation of the secondary blower 50 in this manner could be manually based upon user commands, or operated by a controller 100 (shown schematically as 100 and equally applicable in all embodiments), such as to follow a recipe that may include instructions to establish or maintain a humidity within the baking compartment at one or multiple different levels during the baking process, or to maintain a humidity level within the baking compartment 12 within a desired range (either by actively monitoring the humidity within the baking compartment with a sensor 2000 (shown schematically in FIG. 7, but equally applicable for all embodiments), or by calculating the moisture content within the baking compartment using inputs such as atmospheric relatively humidity, calculated humidity added due to the type of food being baked in the oven or other factors).

In some embodiments, a recipe may call for baking for a portion of time with a relatively high humidity, and a portion of time with a lower humidity. In these embodiments, the secondary blower 50 may be operated to lower the humidity within the baking compartment 12 during the baking process, and a water/steam system (either a flash steam system where water is added into the housing, normally proximate to the fan, or with an external steam generator) may be operated to raise the humidity during the baking process when appropriate.

In other embodiments, the baking device may be provided without a blower wheel, i.e. the device may be a non-convection oven. In these embodiments, the secondary blower 50 would be the only blower associated with the device, and the name “secondary blower” is retained herein for naming convention purposes. In these embodiments, the secondary blower 50 may urge air directly into the baking compartment 12 (i.e. the portion of the baking device that receives the food product therein), or the secondary blower 50 may urge air into an auxiliary compartment within the baking device 10 that is in gaseous communication with the baking compartment such that air that enters into the baking device may ultimately flow into the baking compartment, or in other embodiments, the second blower 50 may urge air into a plenum that is in gaseous communication with the baking compartment 12 or the air handling compartment 14. As discussed elsewhere herein, the introduction of air from the secondary blower 50 into the baking device 10 may increase the overall pressure within the baking device which causes air (which may be of a higher humidity than the air entering through the secondary blower) to urge air within the housing to flow out of the housing through the vent, thereby lowering the humidity within the baking compartment 12.

The discharge of the secondary blower 50 may be selectively isolated by a flapper 54. In some embodiments, the flapper 54 is normally shut to prevent the flow of air from within the air handling compartment 14 to flow into the secondary blower 50 when not in operation. The flapper 54 is configured to open (either by the discharge pressure of the secondary blower 50 or automatically (with a solenoid or other suitable operator (shown schematically as 55a in FIG. 4)) to allow the discharge of the secondary blower 50 to enter the air handling compartment 14, along air flow path V shown schematically in FIG. 2. In other embodiments, the flapper may be biased, or urged, toward the open (or closed) position with a spring 55, or alternatively biased by to the force of gravity acting upon the flapper 54. In embodiments, where the flapper 54 is biased to the closed position, the flapper 54 may be selectively opened by a solenoid or other automatic and remote opening feature (that operates against the biasing force), or may be opened due to the discharge force of the secondary blower 50 imparted upon the flapper 54. Alternatively, in embodiments, where the flapper 54 is biased open, a solenoid or other automatic and remote opening feature (that operates against the biasing force) may be provided to automatically close the flapper 54 when appropriate.

In some embodiments, the secondary blower 50 may include a temperature sensor 99 (shown schematically in FIG. 2, but equally applicable for all embodiments disclosed herein) that may be mounted upstream of the flapper 54, such as at the suction of the secondary blower 50. The temperature sensor is provided to give an indication that the flapper 54 is partially or fully open when the secondary blower 50 is not operating. As can be understood, the flapper 54 is normally shut to isolate the baking and air handling compartments 12, 14 during oven operations to prevent efficiency loses due to heat loss through the secondary blower 50 during operations, as well as to prevent the relatively (and potentially relatively high moisture content) hot air from within the housing 20 from coming into contact with the electrical components and wiring of the secondary blower 50 which might damage the secondary blower 50.

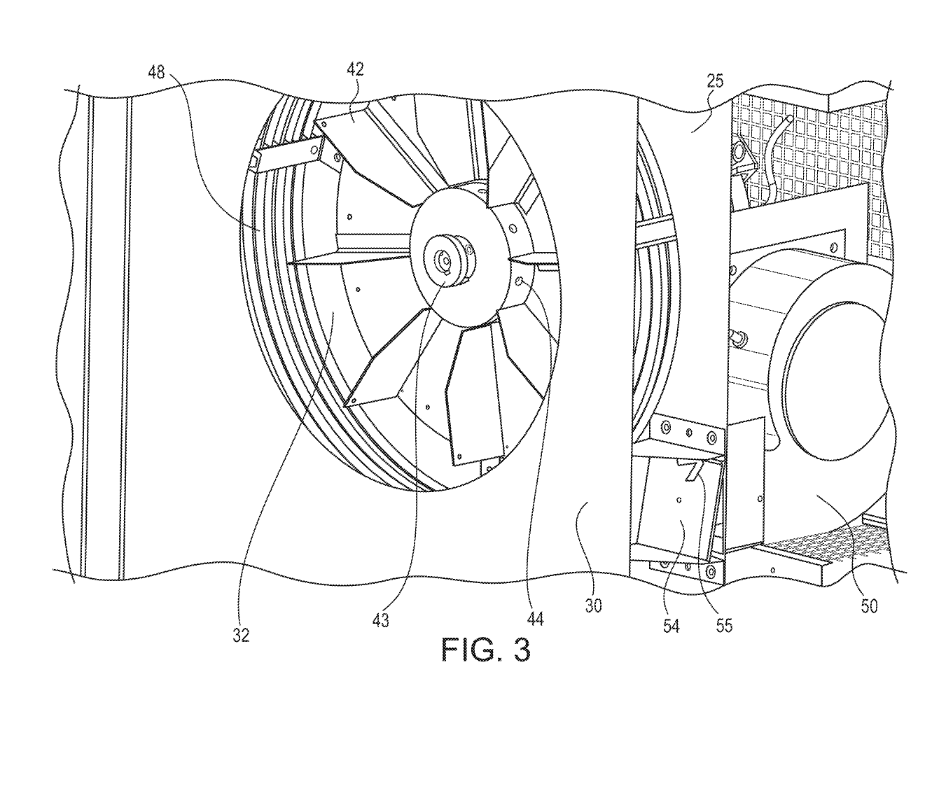

FIGS. 1-4 each show the flapper 54 as partially open, and one of ordinary skill in the art will understand with reference to this specification that the flapper 54 can move to (or be moved to) a position where the discharge of the secondary blower 50 is isolated. One of ordinary skill will also appreciate that the flapper 54 may be able to open more fully than depicted in the figures (such as at an orientation substantially parallel to the direction of air flow from the secondary blower 50) as urged by the air flow, or as urged open by another structure, such as a solenoid valve. In some embodiments, the flapper 54 may be hingedly attached to the housing 20, at one of the top, bottom, or right or left sides of the flapper 54 and be urged to the isolation positions by a spring (shown schematically in FIG. 3 as 55). In other embodiments, the flapper 54 may be a butterfly valve.

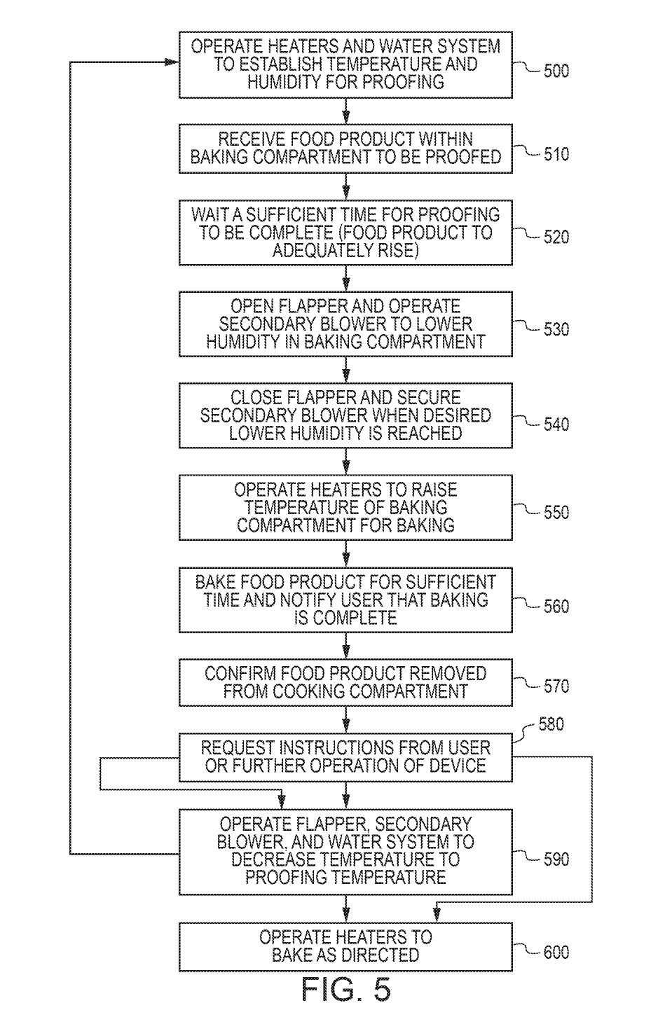

In use and as shown in FIG. 5, the device 10 may operate with the baking compartment 12 operating as a proofer (i.e. a holding environment for a food product (such as dough) to allow the food product to expeditiously rise in the presence of a somewhat elevated temperature over room temperature as well as a relatively high humidity). The device 10 may then be automatically configured such that the baking compartment 12 is converted to a baking environment, with the temperature therein increased to a normal baking temperature (e.g. 350-375 degrees) with a lower humidity than in the proofing step.

Initially, the baking compartment 12 is configured to receive a food product therein (such as fully or partially unrisen bread), which may occur when the baking compartment has a temperature and humidity similar to ambient conditions, or in a situation where the baking compartment has an increased temperature (e.g. to about 90 degrees) and/or with an increased humidity. If the baking compartment 12 needs to be adjusted (either in humidity or temperature) to a proofing environment, then the heating system may be cyclically operated to increase the temperature within the baking compartment 12, and/or the blower wheel 40 and associated water system 49 and spouts 43 may be operated to increase the relative humidity of the baking compartment 12 (through fluid and thermal communication with the air handling compartment 14 through one or more of the aperture 32, and the upper and lower spaces Y, Z) (step 500). The operation of the heating system and/or the blower wheel 40 and water system 49 may be by the controller 100 in response to various parameter measurements of the baking compartment 12 made by temperature, humidity, or other sensors (shown schematically as 200 in FIG. 1) disposed with respect to the baking compartment 12.

After the baking compartment 12 is at a suitable proofing temperature and humidity, the food product is received within the baking compartment 12 (as monitored by the opening and closing of the doors 28, or by an input provided by the operator) (step 510), the baking compartment 12 may be maintained with these conditions for a sufficient time for adequate rising of the food product, as controlled by the controller 100 (step 520). In some embodiments, the controller 100 may be pre-programmed with various “recipes” or operations to control the operation of the device (such as the proofing time) based upon an input by the user (into an input device, either on the baking device 10 or associated with the baking device 10) of the food to be proofed and baked. In other embodiments, the elapsed proofing time may be monitored by the user, and the steps to reconfigure the baking compartment 12 for baking may be directed by the user.

After the completion of the sufficient proofing time, the controller 100 may initiate flow of the secondary blower 50 (step 530). In embodiments where the position of the flapper 54 is controlled by the controller 100 (and not based upon the discharge pressure of the secondary blower 50), the controller 100 provides the appropriate signal to open the flapper 54 prior to initiating the secondary blower 50. The operation of the secondary blower 50 increases the pressure within the baking compartment 12, which urges the air therewithin (with a relatively high humidity) to exit the baking compartment through the vent 80, which is replaced with air that is at the ambient humidity. In some embodiments, the secondary blower 50 may cycle for a sufficient time to replace an amount of air equivalent to a certain number of volumes of the baking compartment 12 (or the combined baking compartment 12 and air handling compartment 14), such as 0.5, 1, 2, 5 or 10 volumes, to ensure that the humidity of the baking compartment 12 has decreased to acceptable levels for baking. In other embodiments, the secondary blower 50 may operate for as long as needed to have the monitored humidity within the baking compartment 12 (as monitored by a humidity sensor 200) to decrease to acceptable levels.

After the secondary blower 50 has operated for a sufficient amount of time and/or an acceptable humidity has been reached (as monitored by the sensors 200 and controller 100), the secondary blower 50 is secured and the flapper 54 is allowed to close (or is closed by the controller 100) (step 540). The heaters 48 then operate to increase the temperature of the baking compartment 12 to the normal baking temperature, as controlled by the controller 100 (step 550) and in some embodiments, the heaters 48 operate during other portions of the proofing cycle and the baking cycle to maintain the appropriate temperature within the baking compartment 12, such as between the proofing and baking cycles. For example, the method may be such that step 550 in FIG. 5 occurs between steps 530 and 540 as depicted on the flowchart on the figure, either in addition to the occurrence of step 550 on FIG. 5 or instead of step 550 on FIG. 5.

In some embodiments, the baking temperature may be stored in the controller 100 based upon a recipe, or the baking temperature may be inputted into the device 10 the user. In some embodiments, the blower wheel 40 may be rotated during the operation of the heaters 48 to increase the uniformity of the temperature within the baking compartment 12 (due to the flow paths X and W, FIG. 2, when the blower wheel 40 is operating). After the desired temperature is reached, the heaters 48 (and blower wheel 40 as appropriate) are cyclically operated to maintain the temperature (either a constant temperature, or in some embodiments a controlled but changing temperature if appropriate) for a desired baking time (step 560). During the baking cycle, the secondary blower 50 may be periodically operated (and the flapper 54 opened) to periodically purge the baking compartment to reduce the moisture content (humidity) within the baking compartment 12. At the conclusion of the baking time, the controller 100 initiates an alarm to notify the user that the food product can be removed from the baking compartment 12.

Upon removal of the food product, the controller further operates the device 10 as desired based upon the user (which may include the user providing certain inputs of the next desired step, i.e. another proofing/baking cycle, another baking (only) cycle, etc.). In some embodiments, the opening and closing of the one or more doors 28 may generate a signal to the controller 100 that the food product has been removed, while in other embodiments, the user may manually indicate that the food product has been removed. The controller 100 in this step confirms that the baked food product has been removed from the baking compartment (step 570).

The controller 100 then may request the user to provide further instructions of what the next operation of the device 10 that is desired (step 580). If the controller 100 receives a signal that another proofing cycle is desired (and receives a signal that the food product has been removed from the baking compartment 12), the controller 100 then cools down the baking compartment 12 to an environment suitable for proofing (step 590). The controller 100 starts the secondary blower 50 (which opens the flapper 54, or the controller 100 causes the flapper 54 to open), which introduces ambient air into the baking compartment 12 and the air handling compartment 14. The operation of the secondary blower 50 increases the pressure within the baking compartment 12, which causes air therewithin to exit the baking compartment 12 through the vent 80. The blower wheel 40 may operate at this time to increase the mixing of the air within the baking compartment 12 and air handling compartment 14, and in some embodiments, the water system 49 and the spouts 44 may introduce water into the air handling compartment 14, to decrease the air temperature due to the energy loss as the water flashes to steam. When the desired proofing temperature is reached (as monitored by the sensors 200 within the baking compartment 12), the secondary blower 50 is secured (and the flapper 54 is closed, either automatically, or by the controller 100). The user is then notified that the baking compartment 12 is ready for another proofing cycle. After the controller 100 senses that a food product to-be-proofed has been placed within the baking compartment 12 (by the signals of the one or more doors 28 opening and closing, or by an input by the user), the controller 100 initiates the next proofing and baking cycle as discussed above.

Turning now to FIGS. 6-8, another baking device 1000 is provided. In many respects the baking device 1000 is similar to the baking device disclosed above, and portions of the baking device 1000 may be the same as similar components discussed above. For the sake of brevity, these similar components will be referred to with the same element numbers as used above.

The baking device 1000 includes a housing 20 that encloses a baking compartment 12 and an air handling compartment 14. The baking compartment may be defined by an upper wall 21, a right wall 23, a left wall (not shown, but similar to the right wall), a lower wall 22, and a pressure panel 30 that defines the rear wall of the baking compartment 12. The walls that form the baking compartment 12 are each rigidly mounted to the housing 20 of the baking device 10 with suitable support and fastening structures as known in the art. The baking compartment 12 is normally enclosed by one or two doors 28 that are pivotably mounted to the housing 20 and can be selectively opened and closed to selectively enclose the baking compartment 12 and allow access therein.

In some embodiments, the baking compartment 12 is vented to the atmosphere through a vent 80, which communicates with the baking compartment 12 through a vent opening 82. The vent 80 may be open to the atmosphere, or in some embodiments may be controlled by a door, which is operatively controlled to expose or conceal the vent by the controller 100 (shown schematically in FIG. 1, with a similar construction when used with the baking device 1000).

In other embodiments as shown in FIG. 6 (which does not depict the air handling compartment 14 and associated structure, which may be similar to that shown in FIGS. 1-5), the baking compartment 12 may be vented to the atmosphere through the drain 1002 of the baking device 1000, or alternatively the baking device 10 discussed above may be modified to be vented to the environment through the drain (similar to the drain shown in FIG. 6 regarding baking device 1000). Specifically, the drain 1002 may be provided as a hole through the bottom wall 22 of the baking compartment 12 (or in other embodiments the air handling compartment 14). The bottom wall 22 of the baking compartment may be angled such that liquid or condensation that on the bottom wall 22 is urged to flow to the drain 1002 due to the force of gravity. Upon entering the drain 1002, the liquid flows through drain piping 1003 toward the outlet 1005, which may be open to the atmosphere, or may be fluidly connected with appropriate plumbing to a drain system. In some embodiments, a trap 1004 may be provided to provide a water seal between interior of the housing 20 and the outlet 1005.

A vent 1080 may be fluidly connected to the drain piping 1003 (normally upstream of the water seal 1004) to eliminate a second penetration into the baking compartment (or the air handling compartment) that is needed to vent the housing. As can be understood with reference to FIG. 6, when the pressure within the housing is above atmospheric pressure (or specifically when the pressure within the housing is sufficiently above atmospheric pressure to overcome the head loss through the drain and vent piping) air from within the housing is urged to flow through the drain 1002 and associated piping 1003 and through vent piping 1080 to the atmosphere. In some embodiments the vent piping 1080 may have an associated outlet valve, such as a flapper valve (loaded by gravity or a spring, or electromechanically controlled) to require that the vent piping be sufficiently above atmospheric pressure such that the differential pressure across the valve causes the valve to open to release the pressure from the vent.

In some jurisdictions, there are regulatory requirements that liquids cannot be drained that are more than a certain temperature, such as 140 degrees Fahrenheit. In some embodiments, the vent 1080 may additionally include a water source 1090, such as a sprayer, that is configured to inject water into the vent line 1080, which drains into the drain piping 1003 and mixes with the liquid that drains from the housing through the drain 1002, with the mixture of the injected water through the vent line and the drained water combining to lower the temperature of the liquid that leaves through the outlet 1005 to an appropriate temperature in conformance with the applicable regulatory requirements.

As shown in FIG. 7, the baking device 1000 may include a secondary blower 1500 such as a fan that draws suction from the environment. The secondary blower 1500 may have a discharge 1504 that is fluidly connected with an outlet of the housing 1100 with the air flowing through the secondary blower 1500 and associated piping 1540 when operating flowing along flow path “C”. The piping downstream of the secondary blower 1500 may be fluidly connected with the baking compartment 12 or the air handling compartment 14. The secondary blower 1500 may be mounted to draw air from the ambient outside of the housing 20 through inlet at the suction 1502 of the secondary blower 1500, which may be positioned on or proximate to the rear wall of the housing 20. Operation of the secondary blower 1500 causes air to be urged into the blower piping 1540.

The housing 20 may include a second piping leg 1100 that takes suction from within the housing (either the baking compartment 12 or the air handling compartment 14). In some embodiments, the second piping leg 1100 may be the vent 80 (which may take suction from a dedicated position within the housing (such as in a side wall or in the top wall), or may be arranged as shown in FIG. 6 where the vent (similar to vent 1080) is connected to the housing through the drain 1002. For the sake of brevity, the second piping leg 1100 will be discussed herein as a separate flow path than the vent 80, but one of ordinary skill will understand that the vent 80 could be used instead of a dedicated second piping leg 1100.

The second piping leg 1100 (or vent) connects with the blower piping 1540 downstream of the discharge from the secondary blower 1500. The second piping leg 1100 and the blower piping 1540 may be connected with a venturi 1610 (shown schematically), such that air flowing from the discharge 1504 of the second blower 1500 flows through the venturi 1610, with the second piping leg connected to the outlet of the venturi. As is known, flowing air through a venturi 1610 causes a pressure drop across the venturi 1610, and causes the second piping leg 1100 to be at a lower pressure than the pressure within the housing. This lower pressure within the second piping leg 1100 urges air to flow through the second piping leg 1100 and out of the housing, thereby lowering the pressure within the housing as shown schematically as flow path “B.” As with the embodiments discussed above, the operation of the secondary blower 1500 ultimately causes air (which may include steam or moisture) to flow out of the housing (including one or both of the baking compartment 12 and the air handling compartment 14), which may lower the humidity within the housing.

In some embodiments, the blower piping 1540 may be disposed at an acute angle α with respect to the approaching second piping leg 1100, and at an obtuse angle γ with respect to the combined exhaust leg 1550. In some embodiments, the angle α may be within a range of 45 to 15 degrees, inclusive of all angles therein, and one of ordinary skill in the art that a smaller angle may result in increased performance because it would make it less likely that the discharge air from the air discharging from the secondary blower 1500 would reach the housing. Similarly, the angle γ may be a relatively large obtuse angle, such as between 135 and 175, inclusive of all angles therein, to minimize any backflow.

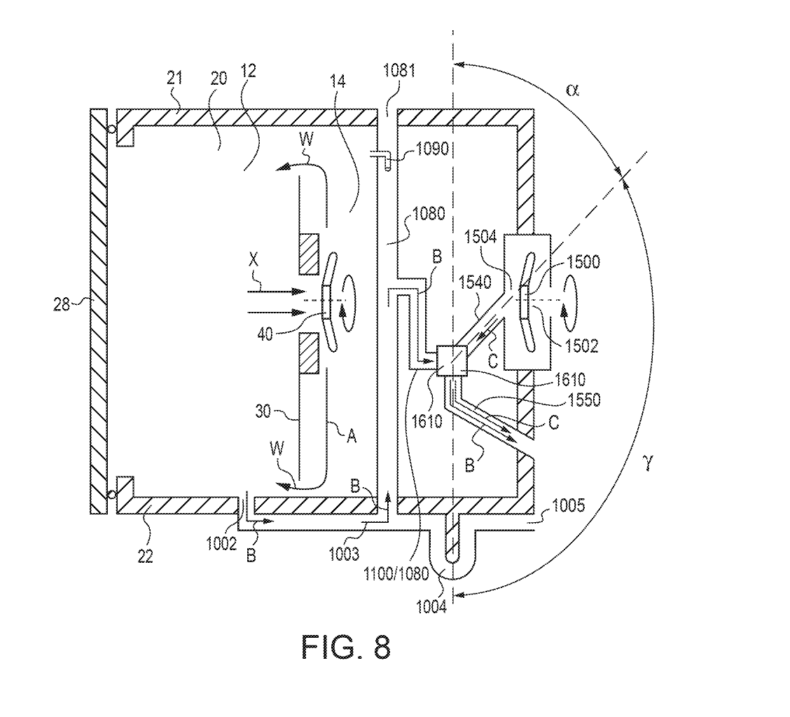

In other embodiments shown in FIG. 8, the baking device 1000 may include a secondary blower 1500, similar to the secondary blower discussed above. The secondary blower 1500 may include a suction 1502 that draws air from outside of the housing (as discussed above) and a discharge 1504 that pushes air through blower piping 1540 that ultimately expels the air out of the housing through an outlet 1100, as shown schematically in flow path “C.”

The blower piping 1540 may be connected to a vent pipe 1080, similar to the vent pipe 1080 discussed above and depicted in FIG. 6. The vent pipe 1080 may be fluidly and gaseously connected to the housing, and specifically one or both of the baking compartment 12 or the air handling compartment 14 through the drain 1002 and associated drain piping 1003. In some embodiments, the vent 1080 may be connected to the blower piping 1540 by (or in conjunction with) a venturi 1610, such that operation of the secondary blower 1500 causes a lower pressure at the outlet of the venturi and the vent pipe 1080 therefore urging gas (air and steam) from within the housing to flow to the vent pipe 1080 and ultimately to the environment through the outlet 1100, as shown schematically in flow path “B.” Accordingly, in the embodiments shown in FIGS. 7 and 8, the secondary blower 1500 may be periodically operated to pull (or vacuum drag) air, gas, and moisture out of the housing when desired.

This operation of the secondary blower 1500 may be beneficial for cooking within the oven such as to reduce the humidity within the baking compartment which may allow food product disposed within the baking compartment to be cooked more quickly than the food product would cook with a more humid environment. The operation of the secondary blower 1500 may also be useful to allow the air within the housing to be changed out without opening the door 28.

While the preferred embodiments have been described, it should be understood that the invention is not so limited and modifications may be made without departing from the invention. The scope of the invention is defined by the appended claims, and all devices that come within the meaning of the claims, either literally or by equivalence, are intended to be embraced therein.

1. A baking device, comprising:
a housing enclosing a baking compartment, the baking compartment enclosed by top and bottom walls, right and left walls, and a door that is pivotably mounted to the housing, the housing further comprising a vent that gaseously connects the baking compartment to the atmosphere and is arranged to allow gaseous communication of air within the baking compartment to exit the housing; and
a blower arranged in gaseous communication with the housing, and configured to, when operating, urge air from the baking compartment into the vent,
wherein the housing further comprises a drain, wherein the vent is in gaseous communication with the drain such that the air that flows from the housing to the vent initially flows through the drain.

2. The baking device of claim 1, wherein the housing further comprises an air handling compartment that is separated from the baking compartment by a pressure panel, the pressure panel establishes one or more gaps to allow air flow between the baking compartment and the air handling compartment.

3. The baking device of claim 1, further comprising a flapper disposed in gaseous communication with a discharge of the blower, such that the flapper prevents backflow of air into the blower from the housing when in a closed position, but allows the flow of air from the blower into the housing when opened.

4. The baking device of claim 3, wherein the flapper is urged toward the closed position, and wherein operation of the blower urges the flapper to the open position.

5. The baking device of claim 1, further comprising a temperature sensor disposed upstream of the flapper.

6. The baking device of claim 1, further comprising a convection blower wheel disposed upon the housing, wherein rotation of the convection blower wheel urges an internal flow of air within the housing, wherein the housing comprises a pressure panel that separates the baking compartment from an air handling compartment, wherein the convection blower wheel is mounted within the air handling compartment and takes suction from the baking compartment, and wherein a discharge of the convection blower wheel is configured to direct air to return to the baking compartment.

7. The baking device of claim 6, wherein the convection blower wheel further comprises one or more fluid ports and a plurality of fins, wherein the baking device is configured to selectively expel a flow of water through the one or more fluid ports when the convection blower wheel is rotating.

8. The baking device of claim 1, wherein the blower is operatively connected with a controller, such that the blower operates in response to a signal from the controller, wherein the controller is configured to operate the blower periodically to maintain a humidity within the baking compartment within a predetermined range, such when the humidity of the baking compartment is at a high level the operation of the blower wheel urges at least a portion of the air at the high level of humidity within the baking compartment to flow out of the housing through the vent.

9. The baking device of claim 8, wherein the baking compartment includes a sensor that is configured to measure a humidity within the baking compartment, and the sensor is configured to send a signal that corresponds to the measured humidity to the controller.

10. The baking device of claim 1, wherein the discharge of the blower is connected to the vent with a venturi.

11. A baking device, comprising:
a housing enclosing a baking compartment, the baking compartment enclosed by top and bottom walls, right and left walls, and a door that is pivotably mounted to the housing, the housing further comprising a vent that gaseously connects the baking compartment to the atmosphere and is arranged to allow gaseous communication of air within the baking compartment to exit the housing; and
a blower arranged in gaseous communication with the housing, and
configured to, when operating, urge air from the baking compartment into the vent, wherein a discharge of the blower is gaseously connected to an environment outside of the housing with a first flow path, and the vent is aligned with respect to the first flow path such that air flowing through the vent merges with air flowing through the first flow path, such that flow of air from the blower through the first flow path urges air to flow through the vent toward the first flow path.

12. The baking device of claim 11, wherein the first flow path comprises a venturi and the vent merges with the first flow path in the venturi.

13. The baking device of claim 11, wherein air that flows through the vent ultimately enters the first flow path and leaves the housing through an outlet.

14. The baking device of claim 11, wherein the housing further comprises an air handling compartment that is separated from the baking compartment by a pressure panel, the pressure panel establishes one or more gaps to allow air flow between the baking compartment and the air handling compartment.

15. The baking device of claim 11, wherein the vent is in gaseous communication with the drain such that the air that flows from the housing to the vent initially flows through the drain.

16. The baking device of claim 11, further comprising a flapper disposed in gaseous communication with a discharge of the blower, such that the flapper prevents backflow of air into the blower from the housing when in a closed position, but allows the flow of air from the blower into the housing when opened.

17. The baking device of claim 11, further comprising a convection blower wheel disposed upon the housing, wherein rotation of the convection blower wheel urges an internal flow of air within the housing, wherein the housing comprises a pressure panel that separates the baking compartment from an air handling compartment, wherein the convection blower wheel is mounted within the air handling compartment and takes suction from the baking compartment, and wherein a discharge of the convection blower wheel is configured to direct air to return to the baking compartment.

18. The baking device of claim 11, wherein the blower is operatively connected with a controller, such that the blower operates in response to a signal from the controller, wherein the controller is configured to operate the blower periodically to maintain a humidity within the baking compartment within a predetermined range, such when the humidity of the baking compartment is at a high level the operation of the blower wheel urges at least a portion of the air at the high level of humidity within the baking compartment to flow out of the housing through the vent.

19. A method of baking a food product, comprising:
receiving an unrisen food product within a baking compartment of a baking device, the baking device comprising a vent path gaseously connected to the baking compartment;
allowing the unrisen food product to rest within the baking compartment for a time to allow the unrisen food product to rise;
operating a secondary blower after the time to allow the unrisen food product to rise is complete, wherein the secondary blower is gaseously connected to an environment outside of the housing with a first flow path, and the vent path is aligned with respect to the first flow path such that air flowing through the vent path merges with air flowing through the first flow path, such that flow of air from the blower through the first flow path urges air to flow through the vent path toward the first flow path; and
heating the baking compartment to bake the food product.

20. The method of claim 19, further comprising the step of operating the secondary blower after the heating step is complete.

21. The method of claim 20, further comprising the step of operating the secondary blower until a measured temperature is within a range suitable for receiving another unrisen food product within the baking compartment and to allow the another unrisen food product to rest within the baking compartment for a time to allow the another unrisen food product to rise.

22. The method of claim 20, further comprising the step of operating the secondary blower for a predetermined time to allow for removal of heated air to cool the baking compartment such that a measured temperature within the baking compartment is within a range suitable for receiving another unrisen food product within the baking compartment and to allow the another unrisen food product to rest within the baking compartment for a time to allow the another unrisen food product to rise.

23. The method of claim 19 wherein the baking device includes a blower wheel that is configured to selectively spray liquid when the blower wheel is rotating, and further comprising the step of spraying liquid from the blower wheel to increase a humidity within the baking compartment.

24. The method of claim 19, further comprising a step of operating the blower wheel after the step of heating the baking compartment to bake the food product is complete and after a step of monitoring a removal of the food product from the baking compartment is complete.
